(19) United States
(12) Patent Application Publication
(10) Pub. No.: US 2018/0104980 A1
(43) Pub. Date: Apr. 19, 2018

(54) Tools for Up-Cycling Beverage Cans into Art Objects, Toys, and Other Items

(71) Applicant: David Allen Tucker, Dallas, TX (US)

(72) Inventor: David Allen Tucker, Dallas, TX (US)

(21) Appl. No.: 15/293,276

(22) Filed: Oct. 14, 2016

(51) Int. Cl. B44B 3/00; B26B 29/06; A63H 33/04

(52) U.S. Cl. CPC B44B 3/00; B44B 2700/02; A63H 33/04; B26B 29/06

(57) ABSTRACT

Tools for transforming cans into parts for art and toys. You lock a can into a tube having openings that indicate locations to poke, cut, mark or slot the can, and this physically supports the can and guides the user's tools. Another tool with a flat, tearing area makes dual cuts on both of its sides simultaneously as it rips material away in a strip, leaving rolled edges behind along the cut that are safer and desirably rigid. Another tool can variably position the can in the tube. Finally, metal panels produced by the tube and can are passed through the roller tools' curved, internal cavities, thereby producing useful metal “carpet rolls.”

### CROSS REFERENCE TO RELATED APPLICATIONS

Not applicable.

### STATEMENT OF FEDERALLY SPONSORED RESEARCH OR DEVELOPMENT (IF ANY)

Not applicable.

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

Not applicable.

### BACKGROUND OF THE INVENTION

### A. Field of the Invention

The present invention relates to up-cycling beverage cans and tools and techniques for making various art objects, toys, and other useful items from them.

### B. Description of the Prior Art

The prior art describes methods for up-cycling beverage cans into useful or artistic objects, such as lanterns, wind spinners, flowers, light boxes, cook stoves, ashtrays, and so on. Examples pervade Etsy and YouTube.

Typically, the first step is to cut the can with scissors, a scalpel, or an exacto knife. This can be difficult and dangerous for an unskilled, novice, or young person. So, outcomes are idiosyncratic, imprecise, wrong, harmful, and aesthetically flawed. You can easily bend, crease, rip or tear the can's metal in unintentional ways while making bad cuts and folds—particularly in the initial stages. Moreover, scissors and knives are dangerous and not kid-friendly; they have and they create sharp edges, and these edges require careful handling. They can lacerate you, but at the same time the aluminum is so flexible once removed from the supporting structure of the can that it is easy to bend or crease it unintentionally. There are limited uses for used beverage cans. So, . . . there ought to be more and better uses for used cans, beyond ordinary recycling.

### BRIEF SUMMARY OF THE INVENTION

I invented a system and set of tools for up-cycling beverage cans into art objects, desk toys, and other useful items. The first tool (the “Sleeve”; FIGS. 1-5) is a tube-like cylinder that surrounds the can itself, like a sleeve (but with upper and lower ledges), and it has a mechanism for variably elevating (FIG. 6; elevatorhole 3; pushpin 10) and locking (pushpin hole 2; pushpin 10) the can in it. It functions as a stencil, ruler, physical guide, support frame, and instruction manual combined so you can mark, poke, slice, slot, and tear the can accurately to make particular designs. When not in use for crafting purposes, it can serve as a Coozie (or as most of one) to maintain a cool beverage temperature. Optionally, the Sleeve can be inserted in an insulated, cup-shaped cover (FIG. 12) having an unfilled lower section that can be used to hold some of the related tools (e.g., the Slot-Maker, Elevator, mini-Rollers, pushpins, tape, or mini-scissors).

The second tool (the “Slot-Maker”; FIGS. 7 & 8) has a sharp, pointy end, a flat tearing side several millimeters in width, a rectangular cross section in its key working area, a handle, and a barrier between the handle and the rest of the tool. It pierces the can wall and enables you to push a strip of aluminum away from and into the can that forms into a roll at the end of the “cut.” The third tool (the “Elevator”; FIG. 6) is an accessory to the Sleeve that allows the can to be variably elevated in the Sleeve and is locked into place (using two opposite elevatorholes 3) as needed. The fourth tool (the “Rollers”; FIGS. 9-11; FIG. 6) is a set of rollers, which are bodies having internal cavities shaped like an open cylinder or like an open frustum of a right cylinder (think of a cone with a flat top) or like a crescent moon with depth. You repeatedly pass rectangular panels of aluminum can through them in series to make metal “carpet rolls” used for various purposes. These tubes can be doubled-up by inserting one in another for strength, and they can be connected to each other in series or in parallel or in columns to make larger structures. The Rollers are symbiotically sized to work with the aluminum panels made by the Sleeve and Slot-Maker, which in turn are designed to make the aluminum panels that make the rollers useful.

These tools provide support and protection to sensitive or dangerous areas while the metal is being manipulated; they help prevent unwanted creases or folds; they indicate what metal is to be manipulated; they protect the hands; they can contain convenient written instructions and warnings; they make communication about locations on the can precise; they accomplish reliable, repeatable results; they can induce confidence in the user; they are kid-friendly; and they are fun to use. They have all the advantages over the prior art that I have listed as needs in the last paragraph of the Description of the Prior Art section above.

The Sleeve, Slot-Maker, Elevator, and Rollers, individually and/or in combination, are useful because they can be used to make: photo-frame pinwheel; scorpion with customizable face, shield and weapons; turtle; armadillo, spider; octopus; jellyfish; elephant; giraffe; swan; crab; Star Wars AT-AT; tank; cannon; artillery piece; coin bank with simple slot-cover; coin bank with spiral ramp input; tea-light holder; floating tealight holder; Wheel of Destiny; novelty glasses; flat aluminum canvases for embossing; soap dishes; bookmarks; buttons, name tags, hangman model; Wheel of Destiny; Christmas tree ornament; slingshot; back scratcher, racetrack; train track; toy roller coaster track and its scaffolding; checkers/chess set; vase; jewelry box; cat toys; suspended target; clutch-purse; staff; picture frame; stool; table; dresser; dollhouse; “carpet rolls” of aluminum sheet metal; and many, many other items. I do not teach how to make each of these designs because the invention lies in the process and tools for making the interim products, not in the ultimate results of the interim products. I show a few of the ultimate designs only to prove the invention's utility and give insight into how the other designs might be made. Many of these items are probably featured in photographs and video by now on my website at www.aluminoids.com.

It is the object of my invention to create a set of tools and teach a system for make art objects, toys and general construction materials from beverage cans that provides predictable, reliable, and accurate results; that creates novel and useful results; that is safe and easy for the unskilled, novice or young person to do; that creates curled edges on cut surfaces, so they are safer to handle and stiffer during manual working and so that the finished product retains a stiffer, more durable shape; that makes the can itself safer to handle during metalworking; that creates a psychological separation between the user's body and the metal can; that is hand-operated, without requiring a table or desk support; that adds meaningfully to the ways in which used cans can be up-cycled; that provides a readily-accessible source of information (or a referral thereto) about how to complete a particular project; that makes communicating instructions about where to cut or poke when making designs easier; that best guides the user's hands and tools into making perfect cuts, pokes, tears, and marks; that has dual functionality as a Coozie for keeping beverages cold; that has an interesting and attractive presentation method for public performances; that has a convenient compartment for storing pushpins and small necessary tools; that is simple enough for children to do; that has tools that appear safe to use; that has tools that actually are safe to use; that minimizes the risk of injury; that provides a positive crafting experience for the user; that facilitates the process of making 2 mm to 10 mm slots in cans; that is extremely simple and intuitive; that is light; that is durable; that is very inexpensive to manufacture; that presents a compelling value proposition to the customer; that is entertaining to watch; that makes the crafting process look easy and safe; that does not simply present a potential solution for one component of a larger, unsolved and unrecognized problem; that enables simple and safe horizontal, vertical, and curved cuts and tears in cans; and that is versatile. My invention has all these advantages and solves all of these problems, which makes it a significant advance over the prior art.

Further objects of the invention will appear as the description proceeds. To the accomplishment of the above and related objects, this invention may be embodied in the form illustrated in the accompanying drawings, attention being called to the fact, however, that the drawings are illustrative only, and that changes may be made in the specific constructions illustrated and described within the scope of the appended claims and/or this specification.

### BRIEF DESCRIPTION OF THE SEVERAL VIEWS OF THE DRAWINGS

Various other objects, features, and attendant advantages of the present invention will become fully appreciated as the same becomes better understood when considered in conjunction with the accompanying drawings, in which reference characters designate the same or similar parts throughout the several views, and wherein:

FIG. 1 is an upper perspective view of the Sleeve, Slot-Maker, Elevator, Coozie, Rollers and pushpins.

FIG. 2 is a front view of the preferred embodiment of the Sleeve.

FIG. 3 is a top view of the preferred embodiment of the Sleeve.

FIG. 4 is an upper perspective view of the horizontal Sleeve.

FIG. 5 is a side view of the horizontal Sleeve.

FIG. 6 is an upper perspective view of the Elevator and pushpins.

FIG. 7 is a side view of the Slot-Maker.

FIG. 8 is a bottom view of the Slot-Maker.

FIG. 9 is an upper perspective view of the moon Roller.

FIG. 10 is an upper perspective view of the frustum Roller.

FIG. 11 is an upper perspective view of the cylindrical Roller.

FIG. 12 is an upper perspective view of the Coozie.

FIG. 13 is an alternate embodiment of the Elevator.

### DETAILED DESCRIPTION OF THE INVENTION

The description given above in the Brief Summary of the Invention section is hereby and herein incorporated by this reference as if stated at length. In the drawings, similar reference characters denote similar elements throughout the several views.

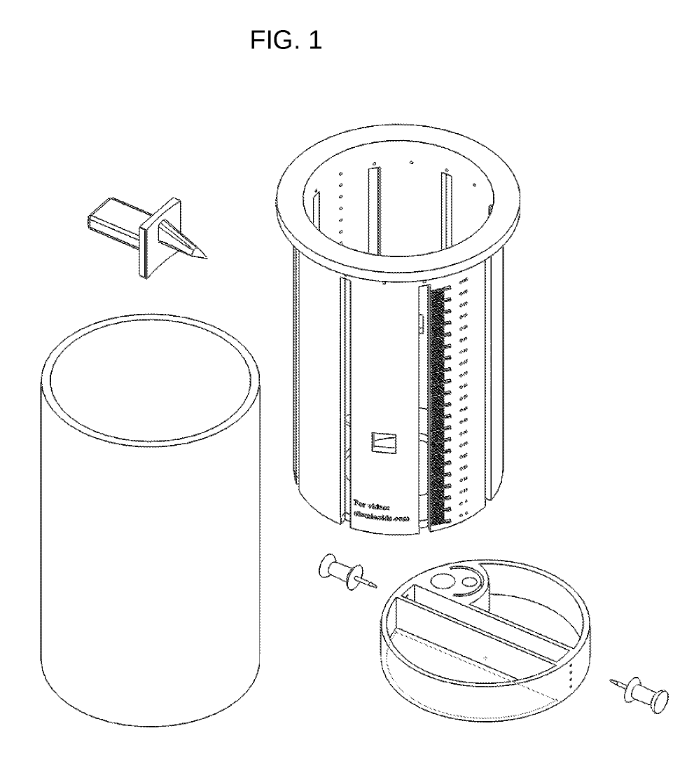

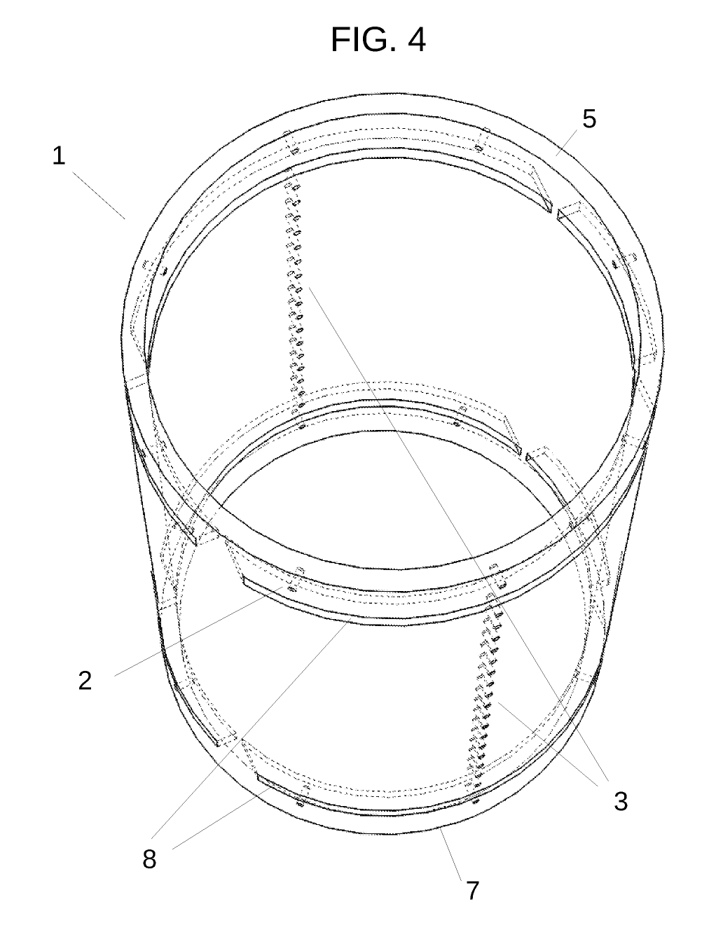

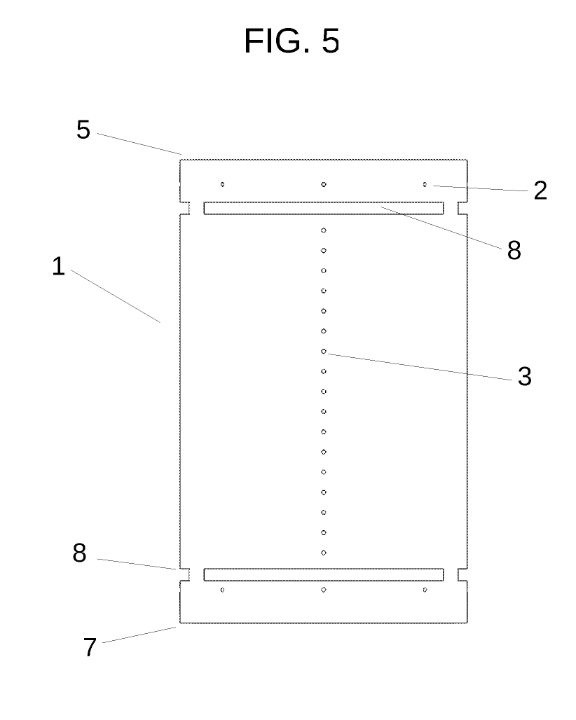

The sleeve tool 1 seen in FIGS. 1-5 is basically a tube with exposed areas and various locking/orientation mechanisms (pushpin holes 1 with pushpin 10; bottom ledge 4; rodhole 6 with rod; Elevator locked-in using elevatorholes 3 and pushpin 10s). It guides the user in making his initial cuts and tears and pokes and slots in the side of a beverage can (which is when the metal is easiest to mishandle). The Sleeve enables repeatable accuracy and consistency while enhancing both the reality and perception of safety. The user keeps his hands on the Sleeve, rather than the can itself, thereby lowing the risk of lacerations, or unwanted bends in the delicate metal. It creates a psychological separation between the user and the metal can—which flimsy paper masks do not. A paper mask or other flimsy cut-out feels like you are just holding a metal can; but my invention feels like you're holding a guard/shield against the can's metal.

The Sleeve is also a teaching tool, since it is a visual and convenient storehouse of readily usable information about locating the cuts and pokes for your particular design—thereby minimizing errors. The Sleeve can bear writing, instructions, warnings, measurements, rulers (ruler 26), referrals to online videos, and passwords for online videos that will make the crafting process better, more accurate, and convenient. For example, I can say, “Make a pushpin poke at vertical marker 60 in panel 7,” or “Lift the Elevator to vertical marker 55 with a pushpin at marker 51,” or, “In your second round of slices, skip slots 1 and 9,” without having to resort to crazy diagrams. For clarity, the figures show only one ruler and elevatorhole 3 line, but it could and should be repeated on every panel of the Sleeve for ease of communication (also, a circumferential ruler could be located between the slot numbers). Finally, the Sleeve engulfs the can and locks it into place or into a particular relative orientation, thereby mechanically supporting it when needed for slot-making (slot-making puts more mechanical stress on the can than slit-making does). Support is particularly necessary for cuts into a can that has been structurally compromised by previous cuts.

The sleeve tool 1 preferentially has a wall thickness of about 2 to 4 mm, depending on the stiffness of the material used to make it. Ideally, sleeve tool 1 should be rigid enough to withstand bending, crushing and mild abuse from the average adult hand and to serve as a guiding edge during cutting. If made from ABS thermoplastic, then a thickness of about 3 mm seems to be adequate. However, the sleeve tool 1 could also be made from a slightly flexible material that is “substantially rigid,” meaning that it is difficult to deform permanently, like a hard rubber, but hard enough to use as a guiding edge for cutting and drawing. The inner diameter of sleeve tool 1 is sized to fit closely around the outer diameter of a standard-sized beverage can, which in the USA is slightly over 65 mm. The sleeve tool 1 has a bottom ledge 4 that blocks the insertion of a beverage can beyond that point and mechanically supports the can against downward forces; at full insertion, the eight slots 6 and the pushpin holes 1 are thereby aligned in the proper position relative to the top and bottom of the can, for maximum cutting range. The bottom ledge 4 could be integrated with sleeve tool 1 as shown in the figures, or it could be created with opposite holes in the sleeve tool 1 through which you insert a crossbar, or it could be made from the Elevator itself, locked with pushpin l Os into a low position.

The pushpin holes 1 can be any size, but preferentially they are about 0.9 millimeters in diameter, which thereby approximates the diameter of most off-the-shelf pushpins. Ideally the diameter of the pushpin holes 1 is slightly smaller than the pushpin 10 pin diameter so that the pushpin holes 1, made from ABS plastic, will expand to grip the pushpin 10 pins and hold them in a fixed position, with very little wiggle-room. The elevatorholes 3 are likewise sized to hold standard pushpins, for identical reasons.

The pushpin holes 1 serve several purposes. First, when a pushpin 10 is inserted through both them and the can metal behind the hole, it holds the beverage can in a non-rotating and non-elevating position while you work on cutting, poking and marking the can. Second, it indexes the original cutting position if you need to rotate the can to make new cuts or if you need to take the can out and then replace it to its original position. For example, if you need to rotate the can by 22.5 degrees, you need only move the hole that the pushpin hole 2 made in the can to its neighboring pushpin hole 1. Third, as mentioned above, they help support the metal when it is structurally compromised. A pin placed through pinhole 1 helps keep the can's metal from bending too much inward while downward pressure is applied to the metal exposed by the slot 8 beneath it. This feature is advantageous in some designs for aesthetic or functional reasons. Fourth, they can hold the Elevator in place at a particular elevation in the sleeve. Fifth, where a custom Sleeve is used, pushpin holes can be placed anywhere on the body to indicate the beginning and ending points where scissor-cuts will be needed later in making a particular design or where marks need to be made.

The sleeve tool 1 shown has eight slots 6 equidistantly and equiangularly placed around its circumference. [By “equiangularly,” in both this specification and the appended claims, I mean that, as measured from the center axis of the can, and taking a cross-sectional center point as the vertex, each of the slots 6 is positioned an equal number of degrees (here, 45 degrees) away from its neighboring slot 8; by “equidistantly,” in both this specification and the appended claims, I mean that the distance from one parallel slot to its neighboring slot, as measured from the center of its contact points with the can, is a constant number; see FIGS. 1-3 for visual elucidation.] When a can is fully inserted down to bottom ledge 4, then the top of the slots 6 are positioned about 20 mm down from the top ring of the can. This aligns the top of the slot 8s with the point on the can where its metal on the can wall transitions from being very thick and hard to penetrate to thinner and easier to penetrate (the “sweet spot”). The corresponding sweet spot on the bottom of the can is about 13 millimeters up from its bottom ring. The slots 6 on the preferred embodiment of sleeve tool 1 extend down past the bottom sweet spot only because the sleeve tool 1 is easier to remove from a thermoplastic injection mold that way. The slots 6 can be any width, but preferably they slightly exceed the width of the inserted part of slot-maker 11 so that the user's cut is prevented from materially drifting laterally while it is being made. The slots in the preferred embodiment are shown as straight, but they could be any shape with any curvature, so long as the user could drag a tool along the slot 8's edge to make the shape of cut that the designer intended. I find that during use, it is best to pick a consistent side of slot 8 and use that side to drag the slot-maker 11 along for each cut.

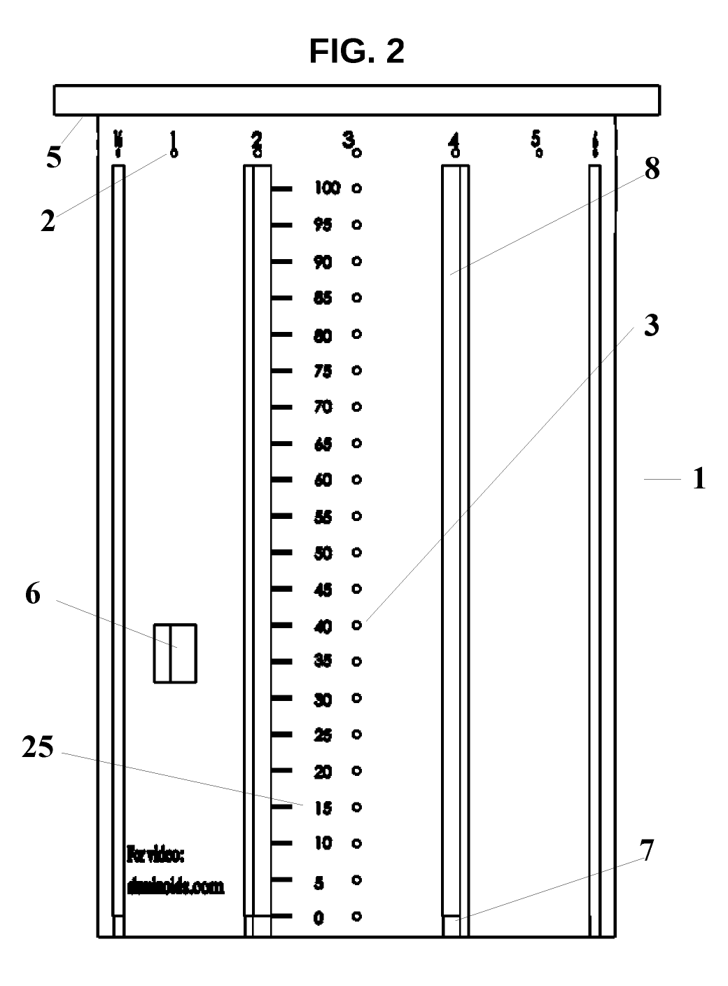

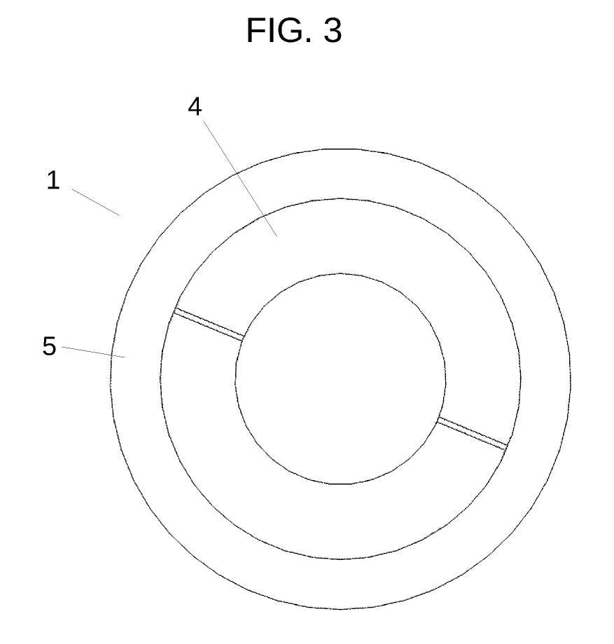

The rodhole 6 in sleeve tool 1 could be anywhere it is needed, but in FIGS. 2 and 3 it is shown at a height which is ideal for lifting the can to the point needed to mark the can for purposes of making a pinwheel. One simply inserts a stiff straw, rod, pen, pencil, or similar item (each, a “rod”) through rodhole 6 and passes its leading end just through its sister rodhole 6 located 180 degrees on the other side of sleeve tool 1. The can is then inserted so that its bottom contacts—and is blocked from further progress by—the rod. Using a marker or pushpin 10, one then marks or scratches a line around the circumference of the can using top ledge 5 to define height of the circle. I find it easiest to rest sleeve 1 on a table, put my marker or pushpin 10 with pressure against the joint where top ledge 5 meets the can, and spin the can. The mark or scratch circle indicates where I will later cut the can with scissors to make the pinwheel's top half (the spinning part, made from the bottom of the can) and bottom half (the pinwheel's base, made from the top of the can, which acts as a stand for the pinwheel's handle/straw/stick). [Alternatively, assuming you have already removed the top of the can, you can elevate the can using the rodholes 9 and a rod, then cut the side of the can exposed above top ledge 5, and then use top ledge 5 like a table-top to cleanly rip a measured strip of aluminum from the can. This technique is good for making tank treads.]

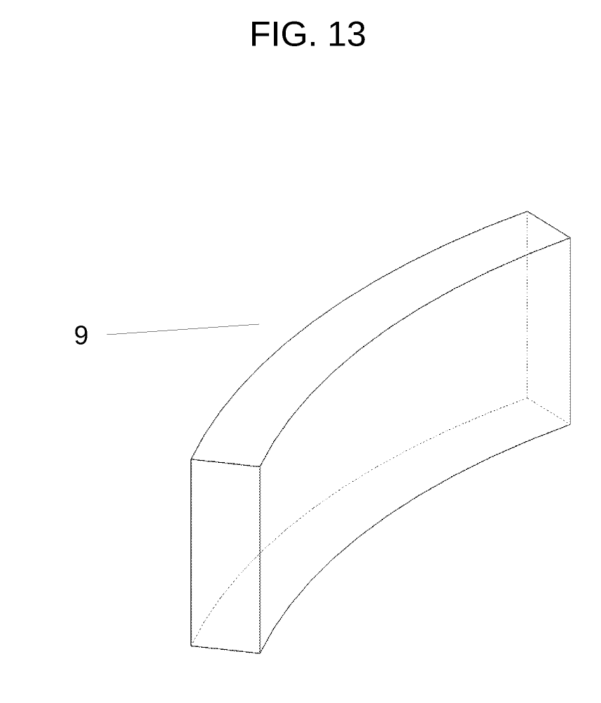

As an alternative to using rodholes 9, you can use the elevatorholes 3 and two pushpin 10s with the elevator 9. In the preferred embodiment, elevator 9 is sized with an outer diameter that equals the outer diameter of the standard-sized beverage can. Elevator 9 should slide easily through sleeve tool 1. By lining up the elevatorhole 3s on sleeve tool 1 with the desired elevatorhole 3 on elevator 9, a set of pushpins run through elevator 9 [one or more on each side of elevator 9 (i.e., 180 degrees around sleeve tool 1)] should make elevator 9 function like a new bottom ledge 4. Ideally, though, the Elevator should be sized to elevate the can exactly where needed, so that using the elevatorholes 3 is not necessary (see FIG. 13), but for the sake of versatility and cost savings the pin-and-hole system is desirable. Multiple Elevators could be stacked, if further fixed elevation is desired. Also, although they are not as easy to stack as the tube-donut-shaped elevator 9s that I describe, the Elevator could alternatively be configured as a rectangular body that is inserted through opposite slots 6, in a manner similar to a rod and rodholes 9. Really, the Elevator could have any shape that doesn't fall through the sleeve, that doesn't change its height, and that prevents the can from being lowered past the Elevator.

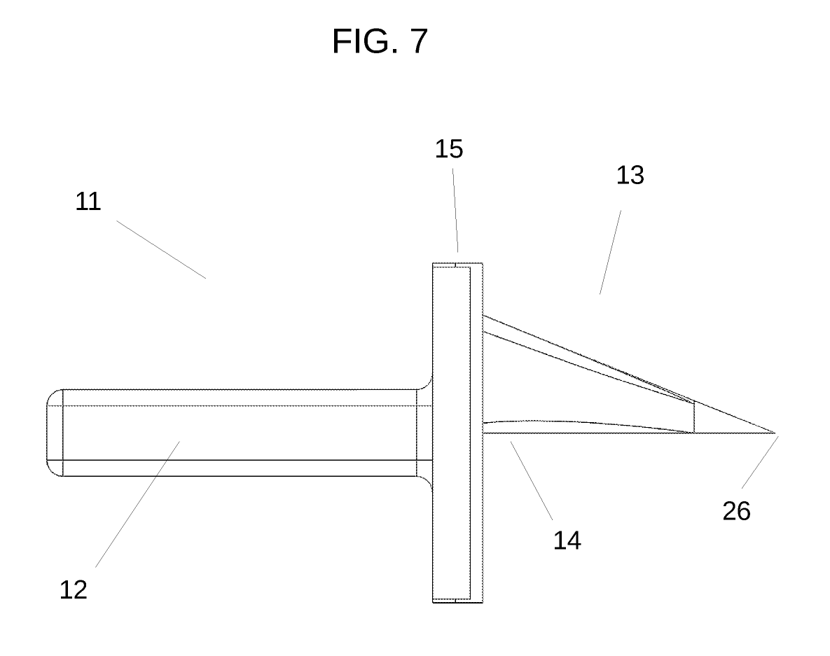

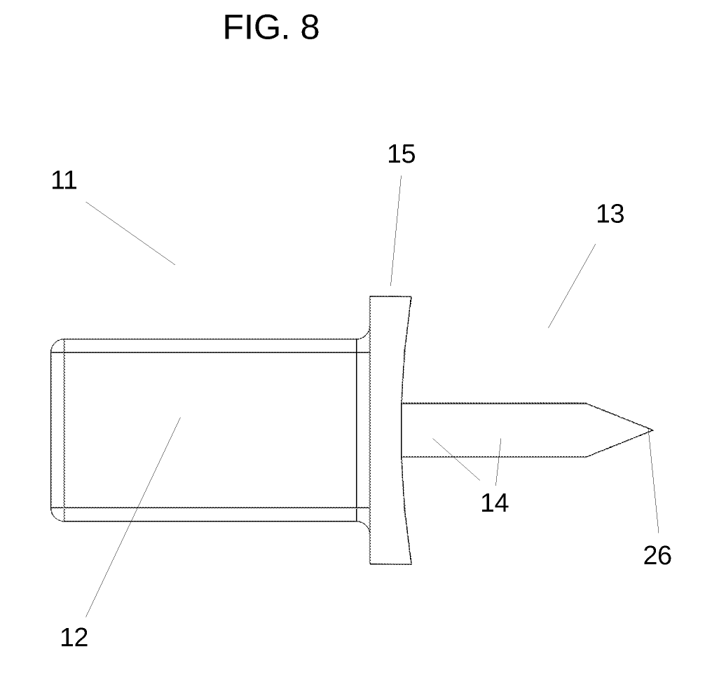

Preferably, you use the Sleeve with the special cutting/tearing tool (the Slot-Maker) that I have designed for it. See FIGS. 7 and 8. As you can guess from its name and structure, the slot-maker 11 is used to cut slots in the metal beverage can at slots 6. The slotmaker 11 has a small, sharp point that easily pierces the can, and its tapering shape facilitates the enlargement of the initial hole in a desirable way. The slotmaker 11 has a flat edge (on cutting surface 14) that can be pressed perpendicularly against the initial opening you made in the can, thereby curling away a small strip of material that rolls up on itself at the bottom of the can. The partially-removed roll of material is safely hidden away at the bottom of can, where it is out of harm's way and is attractive. These rolls have decorative utility in some designs (e.g., they can represent turtle or swan eggs) and functional utility in others (e.g., they can be used to brace straws in the generic flower design).

In some instances one directly inserts slot-maker 11 through slot 8, using its sharp point to penetrate the can, but for some applications where the metal is relatively unsupported, it is best use a pushpin 10 first to make a pilot hole for the slot-maker 11. The business end 13 of slot-maker 11 ideally has a width that nearly matches the width of the slot 8s. This minimizes lateral drift during cutting—keeping slot-maker 11 on the path laid out for it by its slot 8. The upsloping shape of business end 13 helps to expand the initial hole made in the can and to keep the user from rotating the slot-maker 11 during use. The barrier 7 of slot-maker 11 serves several functions. First, it separates the handle 12 from the business end 13. Second, it encourages the user to maintain contact between barrier 7 and sleeve tool 1, thereby aligning the cutting surface 14 with the edge of the hole in the can at the proper location and at the proper perpendicularity (or near-perpendicularity). Third, its design increases the perception of safety (and actual safety) to one's fingers as compared to a knife, scalpel, scissors, or other cutting tool, since the depth and length of a stab wound from it would be limited by the barrier. Fourth, the barrier has a psychological effect on the user. It, as well as the fact that the walls of the sleeve nearly enclose the can, create a separation in the user's mind between the allegedly “dangerous” metal can and the user's hand.

Cutting surface 14 is pressed downward, thereby pushing a strip of metal away from the can which curls into a roll. For durability, I like to manufacture slot-maker 11 with a sharpened nail running through its central axis to make the point; and I adhere 4 or 5 steel staples from a staple gun to the underside of business end 13 to make cutting surface 14. The remaining parts of slot-maker 11 are made from ABS thermoplastic for cost savings. The handle 12 could be any practical design, but a wide, flat top and bottom in parallel alignment is preferred so that its shape induces the user to apply downward pressure on slot-maker 11.

The Slot-Maker is superior to the prior art because it basically yanks the metal strip away from the can's surface on two of its sides as it tears its “cut.” This gives the cut edge of the metal a tiny, rounded, curled shape down the length of the cut. This imbues the edge with a desirable stiffness that enables the cut material to hold the shape it is later given. Also, it makes the edge safer to handle, since the rounded part of the edge will not cut fingers; you can grip the strip by its sides without encountering a sharp edge. Of course, the rounded edge creates a tiny, sharp projection in a roughly 90 degree orientation, but happily its height is typically less than a millimeter, thereby limiting the damage from a potential laceration. [If the rounded edges are undesirable for a particular application, it is easy to smooth them out with a metal object.] The Slot-Maker also creates a gap in the can through which scissors can fit as needed. Another advantage of slot-making over slit-making is that it creates gaps between the panels created by vertical slots/slits. This makes the panels more flexible, particularly near their base, which is important in making some of my designs. The Slot-Maker itself is attractive, easy to use, multifunctional (poking and slot-making), kid-friendly, apparently safe, actually safe, and fun.

The rollers are used for rolling the strips of metal can (the “panels”) that come out of the Sleeve into wound rolls (“carpet rolls”) that are a few millimeters in diameter. Basically, these tools are hollow tubes through which you repeatedly pass the panels in order to make the carpet roll. Were you to try to make carpet rolls without the Rollers, you would quickly tire your hands, and you would get defects in the rolls like bends, creases, accidental flattening, or uneven curling, and you might even cut yourself or abrade your skin.

The rollers can have a variety of possible configurations. For the most part, the outer configuration of frustum roller 16 doesn't matter, but I like to have the outer shape be cylindrical so that I can press an aluminum strip around it to begin shaping/curving the metal. The outer shape of frustum roller 16 could also be rectangular or square in cross-section, since that would help my fingers to rotate frustum roller 16 when needed. The inner cavity of frustum roller 16 could be cylindrical or sloping, shaped like a frustum of a right cone, but I prefer it to be shaped like a frustum of a right cone. The rollers are preferentially made from clear plastic, but any rigid material will do. The smaller hole in the frustum roller 16 is ideally sized so that, when one inserts a panel of aluminum made from the sleeve tool 1 through it many times, the panel will curl into a cross-sectional c-shape that nearly forms an o-shape.

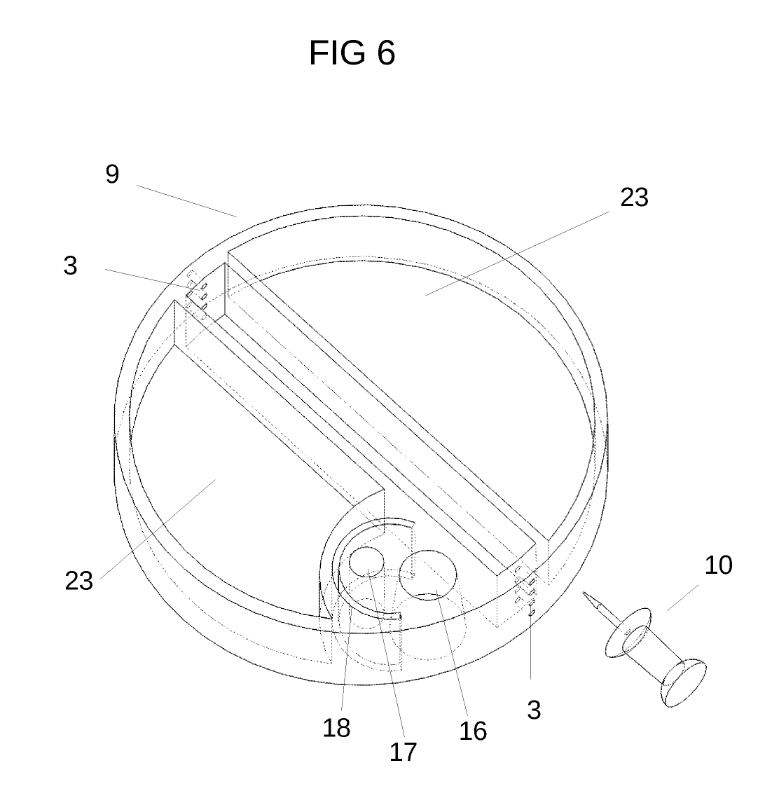

As for the cylindrical roller 17, it is used similarly to its sister, frustum roller 16. One manually rolls the panel (or most of it, or an edge of it) to the requisite diameter and repeatedly inserts it through cylindrical roller 17 to fatigue the metal strip into its desired “carpet roll” shape. I find that a cylindrical inner cavity on cylindrical roller 17 makes the process easier. The cylindrical roller 17 has the flange 19, which could be any shape of outward projection from cylindrical roller 17's side outer surface. The flange 19 make it easier to rotate the cylindrical roller 17 when needed, and the flange 19 help you to shove the cylindrical roller 17 down against the carpet roll (during formation) and a table when that is helpful. Frustum roller and cylindrical roller 17 are preferentially separate, but they could be set side-by-side in one structure for convenience and cost savings. Also, you could graduate the two Rollers' function into three or more Rollers that, used sequentially, help the user make the carpet rolls more gradually. Better still, the Rollers could be sized to fit alongside (or integrated within; see FIG. 6) the Slot-Maker next to a cut-out compartment (compartments 23) inside the Elevator, so that everything important could be concealed and carried in the bottom of the Sleeve while in its Coozie configuration. See FIG. 6.

Now let's consider my preferred embodiment of the Sleeve. FIGS. 1-3 show the most versatile embodiment of the Sleeve, but its design parameters are variable. The Sleeve need not fully encircle the can. The Sleeve can be dimensioned to accommodate any can, regardless of height or diameter. Tall cans can be used in a short Sleeve by flipping the can upside-down and completing the necessary cuts. My preferred embodiment has eight vertical slots, but any number or configuration of slots could be implemented (e.g., 14 or 16; diagonal slots or curved slots). The Sleeve can be plastic, metal, wood, a rigid material, a resilient rubber, or any combination thereof. Also, where the upper edge of the Sleeve is being used to cut a circular slot in a can, the Sleeve need not even be fixed in the can. In that case, it can rotate freely in the Sleeve in its one degree of freedom, so long as the important relative orientations of the can and Sleeve are maintained.

You use the Sleeve as follows. First, you insert an empty aluminum beverage can into the Sleeve until its bottom rests against the bottom ledge 4. You push a pushpin 10 into pushpin hole 2. If necessary for extra holding power, you can insert a second pushpin 10 into a second pushpin hole 2 on the opposite side of the Sleeve. Then, you press the business end 5 of the Slot-Maker through the can at the top of slot 8 until barrier 7 is flush against the Sleeve. You slide the cutting face 10 of the Slot-Maker down an edge of slot 8 until you feel a stopping resistance from the can, thereby opening a perfectly vertical slot in the can. As FIGS. 1-3 show, a total of eight identical slot 8s are positioned equidistantly around the circumference of the Sleeve. You use the Slot-Maker in each of these slot 8s to make a total of eight, equidistant, vertical slots in your can. Remove the pushpin 10s. Remove the Sleeve. Let's call the result, an “8-slice can.” [Incidentally, where a “16-slice can” is desirable, the user only has to rotate an 8-slice can by one pushpin hole 2 (i.e., 22.5 degrees) in the Sleeve, lock it in its new place with pushpin 10s, and make the additional slices. You make the “14-slice can” the same way as the 16-slice can, but you omit a slice on opposite panels (e.g., panels 1 and 9; referenced from using slots 6's 1 and 9 as their left edge).

Horizontal slices and strips can be made from the generic Sleeve fairly easily. You first fix the can in the proper position using pushpin 10s and the pushpin holes 1 (or, use elevator 9). Then use slot maker 11 as explained above, treating the top ledge 5 as if it were an edge of a horizontal slot. [The top ledge 5 helps to maintain the proper alignment of the slot maker 11 as it cuts.] Flip the process to remove the bottom of the can, if needed, using its bottom rim 7 as if it were the top ledge 5. If the final part of the cuts prove difficult, you can use scissors to cut off the top and bottom of the can. Alternatively, to make the bottom cut for example, you could elevate the can into a proper height using the elevator 9 (FIG. 6), then insert the Slot-Maker (pointing in the circumferential direction) into an appropriately sized hole/mini-slot; then manually rotate the can from the top (and the Sleeve from its bottom) to make a circumferential cut into the can.

If further slicing is required, you can elevate the can in the horizontal Sleeve using the elevator 9 (FIG. 6) and either (i) lock it at a height with two pushpin 10s at opposite elevatorholes 3 or (ii) allow it to rest against bottom ledge 4. Alternatively, you can use a pencil or straw as a bar by putting it through both rodholes 9. Then, it's relatively easy to make a cut in the side of the exposed tube of metal and rip the strip away with your hand using the top ledge 5 of the Sleeve as your cutting tool (like peeling an orange). If cylinders instead of strips are desired, an additional Elevator can be placed inside the can so its bottom edge is aligned to where the top side of the Slot-Maker will be cutting. The resulting strips and cylinders of can metal can be cut, folded and scored into bookmarks, a canvas for embossing, a soap dish, a coaster, a small gift box, cookie-cutout silhouette figures, toy tank treads, panels for use with the Rollers (explained below), toy tank body components, a panel for making the toy tank gun, etc.

The 8-slice can made by the preferred embodiment of the sleeve (FIGS. 1-3) is the base configuration for making the following designs: photo-frame pinwheel, tealight, Wheel of Destiny; weathervane, swan, crab, and panels. For example, the photo-frame pinwheel is made by slicing off the top part of the can about ⅔rds of the way up, spreading out the panels on both halves, curling the panels into a pinwheel-like shape, piercing the central axis of the bottom half of the can, jamming the end of a toothpick a few millimeters into this can bottom hole, partially sheathing the toothpick with a short straw segment, and piercing the top part of the remainder of a straw perpendicularly with the exposed part of the toothpick. The concave can bottom holds the image of your choosing. The tealight is simply the top part of the pinwheel laid flat on a table with a tealight placed inside. The weathervane is basically a weathervane which uses the spinning pinwheel part of the photo-frame pinwheel in place of an arrow. The swan and crab are made by cutting the top of the can off at the top of the vertical cuts; then bending the panels back; and then shaping and cutting them with fingers and scissors into the shape of the animal. [Additional instructions and drawings could be helpful here, but keep in mind that my goal is to teach how to use my tools—not necessarily how to best utilize the products of them (e.g., the 8-slice can, the 14-slice can, and the rolled panels/segments).]

Other designs are made from a 16-slice can (a jellyfish, or an octopus, using alternating panels to make the legs and head) or a 14-slice can (a scorpion, turtle, armadillo, and spider) or a custom Sleeve (the elephant, giraffe, and Star Wars AT-AT). A custom Sleeve would have pushpin holes for physically indicating where later, scissor cuts are to begin or terminate or pass through. It might have extremely narrow slots, so that a pushpin 10 can be dragged through it to scratch elaborate marks in the can's paint for indicating later scissor work. Arrows and labels written on the Sleeve might explain the purpose, nature, and location of supplemental working areas (e.g., bend the Elephant's trunk out here with a ribbon curl.”) Designs embossed on the Sleeve might indicate what later cut-outs should look like or where components are to be glued in place.

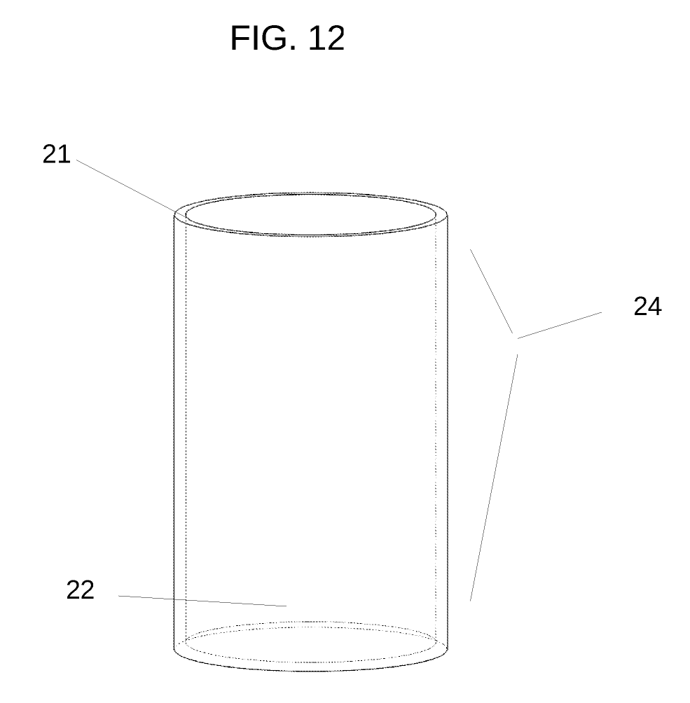

For purposes of showmanship and convenience, the Sleeve could be inserted in a cup-shaped partial cover (the “Coozie”; FIG. 12; a.k.a. the second tube-shaped body) that insulates the beverage while it is being consumed and hides the Sleeve's special nature. The entire structure could be made from an insulative material (insulation 24), or merely part of it, or it could be comprised of a structure containing a partial vacuum that would serve the same insulative purpose. The bottom of top ledge 5 would rest against the upper rim 20 of the Coozie, limiting the downward progress of the sleeve tool 1, and the Coozie would be taller than necessary to create an open area 21 at the bottom of the Coozie. Here, you could store a Slot-Maker, an Elevator, some pushpins, small Rollers, perhaps foldable scissors, etc. The bottom of the Coozie could have short inward projections equiangularly placed around it so that the elevator 9 could rest on it, or it could be a complete or nearly complete surface for better insulative properties. Alternatively (or supplementally), a clip-mount could be integrated in the sleeve tool's top ledge 5 for holding a small bag that contains the storage items.

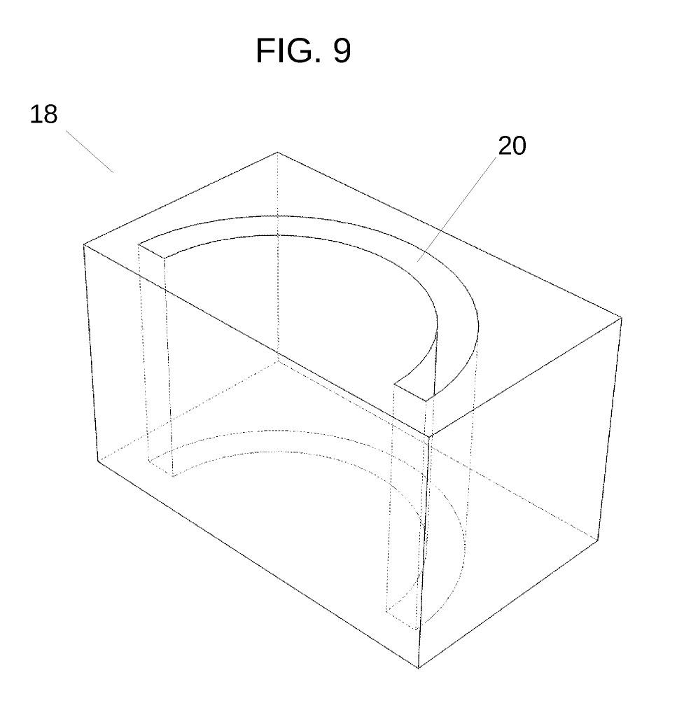

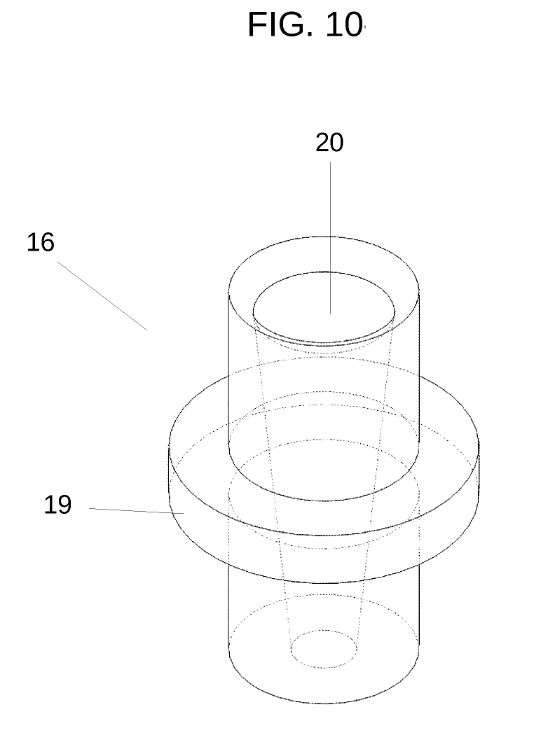

Now let's consider the Rollers. The first Roller (the frustum Roller) (FIG. 10) is preferentially configured as a thick tube having an inner cavity 20 shaped like a frustum of a right circular cone. Begin by wrapping a sleeve strip lengthwise and partially-around the outside of the frustum roller 16, so as to impart the beginnings of a curve down its length. [If you find this first part difficult, repeatedly pass the sleeve strip through the moon Roller of FIG. 9; moon roller 18).] Then, you press the end of the sleeve strip against the inner side of the large end of the frustum roller 16 (as may be necessary) to help further curve the metal without folds or creases, while then passing it repeatedly through cavity 20 of frustum roller 16.

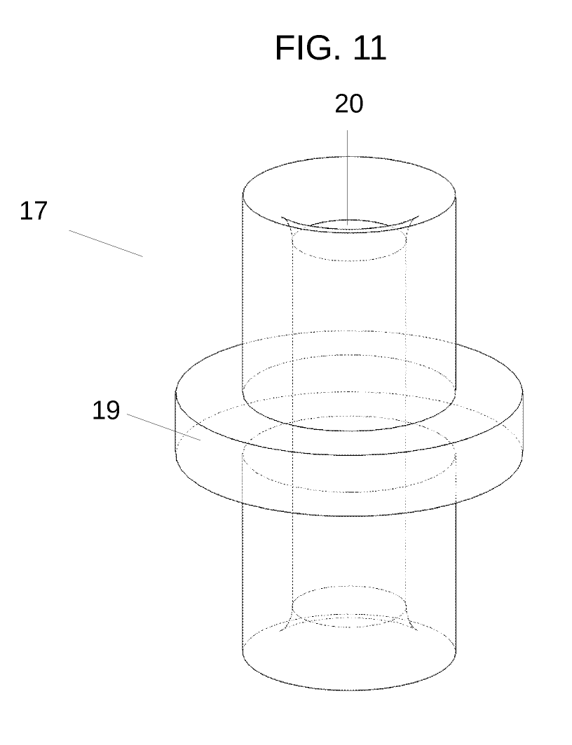

You then manually roll the interim result into an tube-ish shape with overlapping layers and repeatedly feed it through cavity 20 of the next cylindrical roller 17 (FIG. 11), which has a smaller inner diameter. Flange 19 on this cylindrical roller 17 can help you pass the metal roll through in the final stages. The metal will gradually be fatigued into holding its final carpet roll form, without any undesired internal bends, creases, or folds. You can use a larger version of these Rollers and larger metal strips to make a tank gun or artillery cannon in some of my designs.

Carpet rolls can be integrated into larger structures having other components made from wood, metal, 3-D printed thermoplastic, wire, string, and so on (e.g., dollhouse, scaffolding for supporting a roller coaster track, roller coaster track, checkers board, jewelry box, metal straw, picture frame, stool, table). The carpet rolls themselves are versatile, too. You can shorten them with scissors. Or, you can effectively lengthen them by inserting one tube's end into another tube's end and locking them together with adhesive or a crosspin (such as staple that penetrates the crossed area perpendicularly). If additional strength is needed, one or more carpet rolls can be pulled into a smaller diameter and inserted completely into another. Carpet rolls can be combined in other orientations using plumbing-like or Tinkertoy-like connections that are made from a 3-D printer. [For example, consider two rings in a figure-8 configuration that have been twisted so the top and bottom rings face in different directions (say, at a 90 or 45 degree angle to each other); and the rings have crosspin/staple holes at the top and bottom of the 8].

Now let's consider the toy tank, which is a good example of how all these tools often work together. You first use the Sleeve and Slot-Maker to create tube-shaped, horizontal cross-sections of can (“H-slices”), as explained above. Two H-slices of about 15 millimeters height each will be manually pressed into eccentric ellipses to make tank treads. Two H-slices of about 65 mm in height will be put together crosswise (one inside the other in perpendicular orientation) and creased in correct places to make a tank body that is approximately brick-like in shape (but with a slanting front and a less-slanting back). The turret is made from the top 25 millimeters or so of a beverage can; and naturally a hole is cut in its side to fit the barrel of the tank gun. The barrel is made by cutting a H-slice on its side and rolling it up into a large carpet roll using appropriately-sized Rollers, as explained above.

2 mm. holes are poked into the center of the tank body and the turret; and a toothpick is run through the center axis of the tank through the tank body and the turret, thereby aligning and adhering the turret with the body and enabling the turret's rotation with one degree of freedom. Tiny plastic nuts on the toothpick around the turret-hole and the body-hole provide a friction-fit hold the toothpick in place. A plastic piece of my own design wraps around the central toothpick on one end; and on the other end, it wraps around an end of the barrel. The plastic piece permits the barrel to change its firing attitude and to rotate with the turret. The tank treads are affixed to the lower side of the tank body, naturally. Load and light matchheads or Bank Snaps in the barrel for extra fun. Other designs that require the use of the Sleeve, Slot-Maker, and Rollers collectively include the artillery piece, the roller coaster, the hangman, and everything that uses a carpet roll.

It is essential to realize that the Sleeve/Slot-Maker and Rollers are symbiotes, in a manner of speaking, even though they can have independent uses. The Rollers needs the Sleeve/Slot-Maker because (i) it produces the panels that are the raw inputs for the Rollers and (ii) because the rolled edges that the Sleeve/Slot-Maker produces in the panels make the Rollers easier and safer to use. The Rollers are adapted to the Sleeve, since they are particularly-sized for the width and length of the panels. The Sleeve needs the Rollers because they are the best tool for making many designs deriving from the Sleeve (e.g., the tank gun, cannon barrel, hangman, the scaffolding and track for the racetrack and roller coaster). Finally, the Sleeve and Slot-Maker and Elevator are likewise symbiotic, for obvious reasons. So, this is essentially one invention, even if its main components can also have extra, independent utility.

1. An apparatus for tearing vertical, horizontal, or curved slots in a beverage can comprising a substantially rigid body having a bottom cutting surface whose width is or exceeds two millimeters, and further comprising a handle connected to the body.

2. The apparatus of claim 1, wherein an end of the body or handle terminates in a very small, very rigid, surface area that would be suitable for puncturing a side wall of a beverage can.

3. The apparatus of claim 1, further comprising a barrier between the handle and the cutting surface.

4. An apparatus for rolling metal strips of aluminum comprising a body having an internal cavity running completely through it, and wherein an internal wall of the cavity has a substantially concave curvature on at least one of its sides along the cavity's length.

5. The apparatus of claim 4, wherein the internal wall of the cavity is shaped substantially like a frustum of a right circular cone, or a cylinder, or a three-dimensional shape that has a crescent-moon-ish-shaped cross-section along its length.

6. An apparatus for slotting, marking, cutting, and poking an aluminum can and physically supporting it during such actions comprising a substantially tube-shaped body, and wherein the body has an inner diameter that slightly exceeds the outer diameter of a can, and wherein the body has a slot-shaped opening in it, and further comprising a means of maintaining a can placed in the body during use either (i) in an absolute fixed position relative to the body or (ii) in a position that is fixed but with the freedom to rotate in place inside the body.

7. The apparatus of claim 6, further comprising eight, vertical slot-shaped openings, each substantially parallel to the others, arranged equidistantly and equiangularly around the circumference of the body, and whose individual length substantially corresponds to the height of the outermost side wall of a can.

8. The apparatus of claim 6, whereby the body has a rim at one end, and further comprising a flat ledge extending out at least several millimeters from the rim.

9. The apparatus of claim 6, further comprising an opening in the body and further comprising a pushpin, rod, threaded rod, or screw sized to fit the opening.

10. The apparatus of claim 6, wherein the means is a ledge, bar, crossbar, pin, floor, or similar barrier (each, an “obstacle”) connected to or passed through or attached to or removably affixed to or incorporated with the body, and whereby the obstacle during use extends into the volume of space through which a can would pass at any time if a can were to be passed completely through the body.

11. The apparatus of claim 6, further comprising one or more of the following written on the body: diagram, numbering, pointer, indexing system, or ruler.

12. The apparatus of claim 6, further comprising a second tube-shaped body which is sized substantially to wrap and enclose the outer, cylindrical sides of the body.

13. The apparatus of claim 12, wherein the second tube-shaped body is long enough to create an open area for storage underneath the body when the body is inserted into the second tube-shaped body.

14. The apparatus of claim 12, wherein the second tube-shaped body is made of a temperature-insulating material.

15. The apparatus of claim 6, further comprising a means of blocking the complete insertion of a can into the body which also permits the partial insertion of the can into the body.

16. The apparatus of claim 15, wherein the means is an object that is either (i) removably affixed to the body or (ii) sandwiched between the bottom of the can and an obstacle on the other side of the object.

17. The apparatus of claim 15, wherein the object has a compartment.

18. The apparatus of claim 15, wherein the object incorporates the apparatus of claim 4.

19. The apparatus of claim 6, wherein the means causes a part of the body, or something connected to or held by the body, or both, to pierce into or press against the can.

20. The apparatus of claim 19, wherein the means includes, without limitation, one or more of the following: a bar, crossbar, ledge, pin, screw, body-circumference-narrowing means, clamp, or a friction fit.
